(19) United States
(12) Patent Application Publication
(10) Pub. No.: US 2023/0385617 A1
(43) Pub. Date: Nov. 30, 2023

(54) SIGNAL PROCESSING METHOD FOR NEURON IN SPIKING NEURAL NETWORK AND METHOD FOR TRAINING SAID NETWORK

(71) Applicant: Chengdu SynSense Technology Co., Ltd., Chengdu, Sichuan (CN)

(72) Inventors: Sadique UlAmeen SHEIK, Chengdu, Sichuan (CN); Yannan XING, Chengdu, Sichuan (CN); Phillipp WEIDEL, Chengdu, Sichuan (CN); Felix Christian BAUER, Chengdu, Sichuan (CN)

(21) Appl. No.: 18/251,000

(22) PCT Filed: Oct. 11, 2021
(86) PCT No.: PCT/CN2021/123091

§ 371 Date: Apr. 28, 2023

(30) Foreign Application Priority Data
Jul. 16, 2021 (CN) 202110808342.6

(51) Int. Cl. G06N 3/049; G06N 3/084

(52) U.S. Cl. CPC G06N 3/049; G06N 3/084

(57) ABSTRACT

A signal processing method for neurons in a spiking neural network is disclosed. The spiking neural network includes a plurality of layers, each of the layers includes a plurality of neurons, and the signal processing method includes following steps: a receiving step: at least one neuron configured to receive at least one path of input spike train, an accumulation step: performing weighted summation based on the at least one path of input spike train to obtain a membrane potential, and an activation step: when the membrane potential exceeds a threshold value, determining an amplitude of a spike fired by the at least one neuron based on a ratio of the membrane potential to the threshold value.

### CROSS-REFERENCE TO RELATED APPLICATIONS

This application is a US national phase application based upon an International Application No. PCT/CN2021/123091, filed on Oct. 11, 2021, which claims priority to Chinese Patent Application No. 202110808342.6, filed with the Chinese Patent Office on Jul. 16, 2021, and entitled “SIGNAL PROCESSING METHOD FOR NEURON IN SPIKING NEURAL NETWORK AND METHOD FOR TRAINING SAID NETWORK”. The entire disclosures of the above application are incorporated herein by reference.

### TECHNICAL FIELD

The present invention relates to spiking neurons, and particularly to a signal processing method for neurons in a spiking neural network and a network training method.

### BACKGROUND

The spiking neural network (SNN) is currently the best neural network that simulates the working principle of biological nerves. However, due to its inherent discontinuity and nonlinear mechanism, it is difficult to construct an efficient supervised learning algorithm for SNN, which is a very important topic in this field. The spiking generation function is not differentiable, such that the conventional standard error backpropagation through time is not directly compatible with SNN. A popular approach is to use surrogate gradients to solve this issue, such as prior art 1:

Prior art 1: Shrestha S B, Orchard G. Slayer: Spike layer error reassignment in time[J]. arXiv preprint arXiv:1810.08646, 2018.

However, such techniques only support a single-spike mechanism at each time step. For spike data such as DVS data with extremely high time-resolution inputs, using the single-spike mechanism would result in an extremely large and unacceptable number of simulation time steps. This may lead to the fact that the network training method of the single-spike mechanism may become extremely inefficient when facing complex tasks, especially in the face of the increasing scale of configuration parameters.

In order to solve/alleviate the above-mentioned technical problems, the present invention provides an automatic differentiable spiking neuron model and training method capable of generating multiple spikes in one simulation time step. This model/training method can greatly improve training efficiency.

### SUMMARY

In order to improve a training efficiency of a spiking neural network, the present invention achieves the purpose in the following: A signal processing method for neurons in a spiking neural network, wherein the spiking neural network comprises a plurality of layers, each of the layers comprises a plurality of neurons, and the signal processing method comprises following steps: a receiving step: at least one neuron configured to receive at least one path of input spike train; an accumulation step: performing weighted summation based on the at least one path of input spike train to obtain a membrane potential; and an activation step: when the membrane potential exceeds a threshold value, determining an amplitude of a spike fired by the at least one neuron based on a ratio of the membrane potential to the threshold value.

In an embodiment, determining the amplitude of the spike fired by the at least one neuron based on the ratio of the membrane potential to the threshold value comprises: wherein in a single-simulation time step, an amplitude of an fired spike is related to the ratio of the membrane potential to the threshold value.

In an embodiment, determining the amplitude of the spike fired by the at least one neuron based on the ratio of the membrane potential to the threshold value comprises: wherein in a single-simulation time step, the ratio of an amplitude of an fired spike to a unit spike amplitude is equal to a rounded down value of the ratio of the membrane potential to the threshold value.

In an embodiment, performing weighted summation based on the at least one path of input spike train to obtain the membrane potential comprises: performing weighted summation based on a post synaptic potential kernel convolved with each path of input spike train to obtain the membrane potential.

In an embodiment, performing weighted summation based on the at least one path of input spike train to obtain the membrane potential comprises: performing weighted summation based on the post synaptic potential kernel convolved with each path of input spike train and performing convolution of a refractory kernel with an output spike train of the neuron to obtain the membrane potential.

In an embodiment,

$$v ( t ) = {\sum }_{j} {ω}_{j} ( ϵ * {s}_{j} ) ( t ) ,$$

wherein ν(t) is the membrane potential of the neuron, ωⱼ is a jth synaptic weight, ϵ(t) is the post synaptic potential kernel, sⱼ(t) is a jth input spike train, ‘*’ is a convolution operation, and t is time.

In an embodiment,

$$v ( t ) = ( η * {s}^{′} ) ( t ) + {\sum }_{j} {ω}_{j} ( ϵ * {s}_{j} ) ( t ) ,$$

wherein ν(t) is the membrane potential of the neuron, η(t) is the refractory kernel, s′(t) is the output spike train of the neuron, ωⱼ is a jth synaptic weight, ϵ(t) is the post synaptic potential kernel, sⱼ(t) is a jth input spike train, ‘*’ is a convolution operation, and t is time.

In an embodiment, the post synaptic potential kernel is ϵ(t)=(ϵₛ*ϵ_{ν})(t), a synaptic dynamic function is ϵₛ(t)=e^{-t/τ}^{ₛ}, a membrane dynamic function is ϵ_{ν}(t)=e^{-t/τ}^{_{ν}}, τₛ a synaptic time constant, τ_{ν} is a membrane time constant, and t is time.

The refractory kernel is η(t)=−θe^{-t/τ}^{_{ν}}, θ is the threshold value, and when ν(t)≥θ, s′(t)=└ν(t)/θ┘, or otherwise s′(t)=0.

A training method of a spiking neural network, wherein the spiking neural network comprises a plurality of layers, and each of the layers comprises a plurality of neurons, comprising: when the neurons process signals in a network training, following steps are included: a receiving step: at least one neuron configured to receive at least one path of input spike train; an accumulation step: performing weighted summation based on the at least one path of input spike train to obtain a membrane potential; and an activation step: when the membrane potential exceeds a threshold value, determining an amplitude of a spike fired by the at least one neuron based on a ratio of the membrane potential to the threshold value; wherein a total loss of the spiking neural network comprises a first loss and a second loss, the first loss reflects a gap between an expected output of the spiking neural network and an actual output of the spiking neural network, and the second loss reflects an activity or an activity level of the at least one neuron.

In an embodiment, the training method further comprises: detecting a peak value of an output trace; calculating the first loss at a moment corresponding to the peak value of the output trace; calculating the second loss, wherein the second loss reflects the activity or the activity level of the at least one neuron; combining the first loss and the second loss into the total loss; and using an error backpropagation algorithm to train a neural network based on a function corresponding to the total loss.

In an embodiment, combining the first loss and the second loss into the total loss comprises: [symbol] = [symbol] _{CE}+α [symbol] _{act}, wherein a parameter α is an adjustment parameter, the total loss is [symbol] , the first loss is [symbol] _{CE}, and the second loss is [symbol] _{act}.

In an embodiment, the second loss is [symbol] _{act}=(Nₛₚₖ^{†}/(T·Nₙₑᵤᵣₒₙₛ))², wherein T is a duration, Nₙₑᵤᵣₒₙₛ is a size of a population of neurons, Nₛₚₖ^{†}=Σₜ₌₁^{T}ΣₗNᵢ^{t}H(Nᵢ^{t}−1), H(·) is a Heaviside function, and Nᵢ^{t} is an ith neuron at the moment of a time step t.

In an embodiment, the first loss is

$${ℒ}_{C E} = - {\sum }_{c} {λ}_{c} log ( {p}_{c} ) ,$$

when a class label of a category c matches a current input, λc=1, or otherwise λc=0; p_{c} is an indicator of a relative possibility that a neural network predicts that the current input belongs to the category c.

In an embodiment, a periodic exponential function or a Heaviside function is used as a surrogate gradient.

A training device comprises a memory and at least one processor coupled to the memory, wherein the at least one processor is configured to execute the training method of the spiking neural network included in any of the above methods.

A storage device is configured to store a source code written by the training method of the spiking neural network included in any of the above methods through a programming language, or/and machine codes that is directly runnable on a machine.

A neural network accelerator comprises a neural network configuration parameter deployed on the neural network accelerator and trained by the training method of the spiking neural network included in any of the above methods.

A neuromorphic chip comprises a neural network configuration parameter deployed on the neuromorphic chip and trained by the training method of the spiking neural network included in any of the above methods.

A neural network configuration parameter deployment method is configured to deploy the neural network configuration parameter trained by the training method of the spiking neural network included in any of the above methods to a neural network accelerator.

A neural network configuration parameter deployment device is configured to store the neural network configuration parameter trained by the training method of the spiking neural network included in any of the above methods and transmit the configuration parameter to a neural network accelerator through a channel.

A neural network accelerator comprises when the neurons included in the neural network accelerator perform reasoning functions, the above signal processing method for neurons is applied.

In an embodiment, a spiking event of the neural network accelerator comprises an integer.

In addition to the above purpose, compared with the prior art, some different embodiments of the present invention further have one or more of the following advantages:
1. In addition to improving a training speed, for the same model and training method, an accuracy of the model/training method can also be improved.
2. Inhibit an activity of neurons, maintain a sparsity of calculation, and reduce a power consumption of a neuromorphic chip.
3. The learning of spike times can converge more quickly.
4. When calculating a membrane potential, a calculation amount of a convolution operation in one time period is much lower than a calculation amount of each time step.

The technical solutions, technical features, and technical means disclosed above may not be completely identical or consistent with the technical solutions, technical features, and technical means described in the subsequent detailed description. However, these new technical solutions disclosed in this part also belong to a part of many technical solutions disclosed in the present invention document. These new technical features and technical means disclosed in this part are combined with the technical features and technical means disclosed in the subsequent detailed description in a reasonable combination to disclose more technical solutions, which are beneficial supplements to the detailed description. Similarly, some details in the drawings of the specification may not be explicitly described in the specification. However, if those skilled in the art can infer its technical meaning based on the descriptions of other relevant text or drawings of the present invention, common technical knowledge in the field, and other existing technologies (such as conferences, journal papers, etc.), then the technical solutions, technical features, and technical means that are not explicitly recorded in this part also belong to the technical content disclosed in the present invention, and can be used in combination as described above to obtain corresponding new technical solutions. The technical solution composed of all the technical features disclosed in any position of the present invention is used to support the summary of the technical solution, the modification of the patent document, and the disclosure of the technical solution.

### BRIEF DESCRIPTION OF THE DRAWINGS

FIG. 1 is a schematic diagram of SNN neural network architecture.

FIG. 2 is a schematic diagram of a signal processing mechanism of a single spiking neuron.

FIG. 3 is a schematic diagram of a signal processing mechanism of a multi spiking neuron.

FIG. 4 is a function graph of a surrogate gradient.

FIG. 5 is a flowchart of a construction of a loss function during a training process.

FIG. 6 is a schematic diagram of an output trace and a peak time.

FIG. 7 is a schematic diagram that neurons are trained to fire spikes at precise moments and a population of neurons is trained to generate patterns.

### DETAILED DESCRIPTION OF ILLUSTRATED EMBODIMENTS

The “spike” mentioned anywhere in the present invention refers to the spike in the field of simulated neuromorphic, which is also called “peak”, not the pulse in the general circuit. The training algorithm can be written as a computer program in the form of computer code, stored in a storage medium, and read by a computer processor (such as a high-performance GPU device, FPGA, ASIC, etc.). Under the training of training data (various data sets) and training algorithms, obtain a neural network configuration parameter that can be deployed in a simulated neuromorphic device (such as a brain-inspired chip). The simulated neuromorphic device configured with this parameter may gain a reasoning capability. Based on a signal obtained by a sensor (such as DVS that perceives light and dark changes, special sound signal acquisition equipment, etc.), the simulated neuromorphic device reasons about the signal, and outputs a reasoning result (such as through a wire, a wireless communication module, etc.) to other external electronic device (such as MCU, etc.) to achieve linkage effects. The technical solutions and details related to the neural network that are not disclosed in detail below generally belong to conventional technical means/common knowledge in this field. Due to space limitations, the present invention does not introduce them in detail. “Based on . . . ” or similar expressions in the text indicate that at least the technical features described here are used to achieve a certain purpose, which does not imply that only the described technical features are used, and may also include other technical features, especially in the claims. Unless it means division, “/” at any position in the present invention means logical “or”.

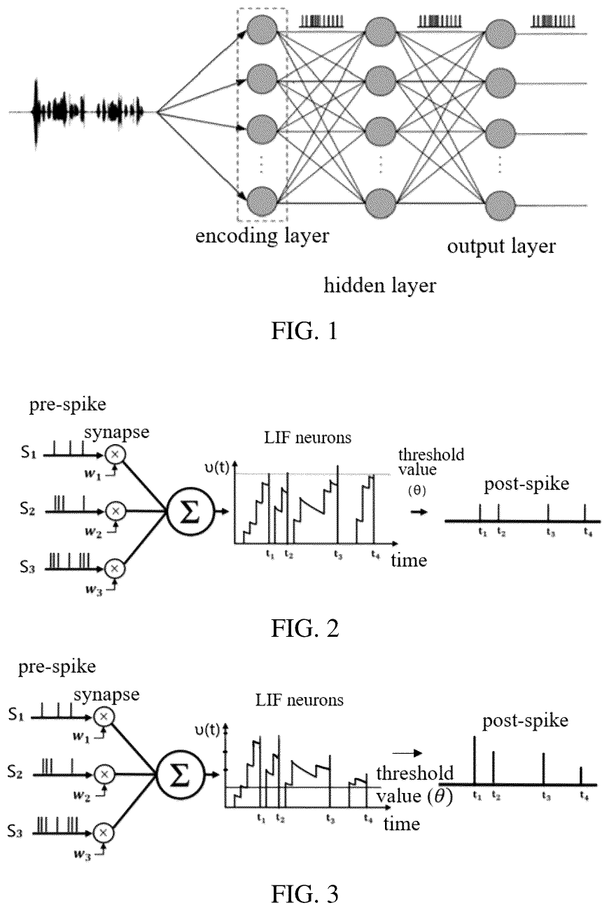

SNN has a similar topology to traditional artificial neural networks but has a completely different information processing mechanism. Referring to a SNN network structure as illustrated in FIG. 1, after a speech signal is collected, the speech signal is encoded by an encoding layer (including several encoding neurons), and the encoding neuron transmits an output spike to a hidden layer of a next layer. The hidden layer includes several neurons (shown as circles in the figure), and each neuron weight and sums each path of input spike trains based on a synaptic weight, and then outputs the spike trains based on an activation (also called excitation) function and transmits it to the next layer. What is shown in the figure is only a network structure containing one hidden layer, and the network can be designed with multiple hidden layers. Finally, a result is output at an output layer of the network.

1. Neuron Model

The neuron model is a basic unit of a neural network, which can be used to construct different neural network architectures. The present invention is not aimed at a specific network architecture, but any SNN utilizing this neuron model. Based on a data set and a training/learning algorithm, after training the network model with a specific structure, a learned neural network configuration parameter is obtained. Deploy a neural network accelerator (such as a brain-inspired chip) with the trained configuration parameter. For any input, such as sound, image signal, etc., the neural network can easily complete the inferential work and realize artificial intelligence.

In an embodiment, LIF neuron model uses a synaptic time constant τₛ and a membrane time constant τ_{ν}. The subthreshold dynamics of neurons can be described using the following formula:

$$\dot{v} ( t ) = - v ( t ) / {τ}_{v} + {i}_{s} ( t )$$

$${\dot{i}}_{s} ( t ) = - {i}_{s} ( t ) / {τ}_{s} + \sum {ω}_{j} {s}_{j} ( t )$$

Both \dot{ν}(t) and \dot{i}ₛ(t) are derivative/differential quotient notations, that is,

$$\dot{v} ( t ) = \frac{dv}{dt} and {\dot{i}}_{s} ( t ) = \frac{{di}_{s}}{dt} ;$$

ν(t) is a membrane potential, iₛ(t) is a synaptic current, ωⱼ is a jth synaptic weight, sⱼ(t) is a jth/jth path in an input spike train (“/” is logical “or”), and t is time.

In order to further improve simulation efficiency, in an embodiment, the present invention simulates LIF neurons through the following spike response model (SRM):

$$v ( t ) = ( η * {s}^{′} ) ( t ) + {\sum }_{j} {ω}_{j} ( ϵ * {s}_{j} ) ( t )$$

Post synaptic potential (PSP) kernel is ϵ(t)=(ϵₛ*ϵ_{ν})(t), synaptic dynamic function is ϵₛ(t)=e^{-t/τ}^{ₛ}, membrane dynamic function is ϵ_{ν}(t)=e^{-t/τ}_{ν}, refractory kernel is η(t)=−θe^{-t/τ}^{_{ν}}, which also belongs to a negative exponential kernel function and has the same time constant τ_{ν} as the membrane potential, “*” is a convolution operation, j is a counting label, s′ or s′(t) are neuron output spike trains, and t is time. That is, perform weighted summation based on the post synaptic potential kernel convolved with each path of input spike train and perform convolution of a refractory kernel with an output spike train of the neuron to obtain the membrane potential.

In an alternative embodiment, non-leaking IAF (integrate and fire) neuron is:

$$v ( t ) = {\sum }_{j} {ω}_{j} ( ϵ ⋆ {s}_{j} ) ( t ) .$$

Post synaptic potential kernel is ϵ(t)=(ϵₛ*ϵ_{ν})(t), synaptic dynamic function is ϵₛ(t)=e^{-t/τ}^{ₛ}, membrane dynamic function is ϵ_{ν}(t)=e^{-t/τ}^{_{ν}}, “*” is a convolution operation, and j is a counting label. That is, perform weighted summation based on the post synaptic potential kernel convolved with each path of input spike train to obtain the membrane potential.

In traditional SNN solutions, for each time step, a spiking excitation function is cycled to calculate the membrane potential, which is a time-consuming operation. However, in the present invention, for example, for 100 time steps, input spikes of these 100 time steps are convoluted by the above-mentioned kernel function, such that the membrane potential corresponding to these 100 time steps can be obtained, thereby greatly improving information processing efficiency of neurons.

In the traditional LIF model, after the membrane potential exceeds a threshold value θ, the membrane potential may be reset to a resting potential. Referring to FIG. 2, for a neuron with a single-spike mechanism, it receives multiple path/at least one path of spike trains (pre-spike) sⱼ, summed under the weighting of the synaptic weight ωⱼ, the obtained membrane potential is then compared with the threshold value θ. If the threshold value is exceeded, the neuron generates a post-spike at the time step (t1-t4), all generated spikes have a uniform fixed unit amplitude, which constitutes a neuron output spike train, which is the so-called “single-spike mechanism”.

Usually in the prior art, the “multi-spike” mechanism described later is not used in a single-simulation time step, especially when the time step is small enough that the multi-spike mechanism is not needed. However, the single-spike mechanism with smaller time steps means a large and unaffordable number of simulation time steps, which makes the training algorithm extremely inefficient.

However, in an embodiment, we may subtract a threshold value θ, which is a fixed value, and can also be set to a dynamic value in some embodiments. If the membrane potential exceeds Nθ, the neuron produces a spike of N times the unit spike amplitude (it can be called N spikes or multi-spike vividly, referring to the superposition of amplitudes at the same time step), the membrane potential is subtracted proportionally, where N is a positive integer value. The advantage of this is that the time and computational efficiency of the optimization simulation can be improved. The neuron output spike train is described in mathematical language as:

$${s}^{′} ( t ) = \{ \begin{matrix}⌊ v ( t ) / θ ⌋ , & if v ( t ) \geq θ \\ 0 , & otherwise\end{matrix} .$$

That is, in an embodiment, when the membrane potential of a neuron satisfies a certain condition, determine the amplitude of the generated spikes in terms of the membrane potential versus the threshold value at one simulation time step, that is, the “multi-spike” mechanism of the present invention (the “multiple” spikes here can be understood as multiple unit amplitude spikes superimposed on the same time step). The spike amplitude generated by the specific multi-spike mechanism can be determined based on a ratio relationship between the membrane potential and a fixed value (such as a threshold value). For example, it can be the Gaussian function of ν(t)/θ in the above formula (rounded down), and it can also be some other function transformation relationship, such as the rounding up of the Gaussian function, or some kind of linear or nonlinear transformation of the value after the aforementioned rounding. That is, at a single simulation time step, the amplitude of the fired spike is related to the ratio of the membrane potential to the threshold value. “s′=1” here means a spike with unit amplitude (i.e., unit spike). That is, the above formula discloses that at a single simulation time step, the ratio of the amplitude of the fired spike to the unit spike amplitude is equal to the rounded down value of the ratio of the membrane potential to the threshold value.

Referring to FIG. 3, unlike single-spike mechanism neurons, after receiving at least one path/at least one pre-spike (input spike train), if the membrane potential of the neuron exceeds the threshold value θ several times, then the neuron may generate a post-spike with a unit amplitude several times (or related to this multiple) height at this time step (t1-t4), which constitutes the neuron output spike train.

This mechanism of generating multiple spikes allows for more robustness in simulation time steps. The advantage brought by this mechanism also includes that relatively larger time steps can be selected in the simulation. In practice, we have found that some neurons produce this so-called multi-spike from time to time.

What has been described above is the training phase/method in the training device and the signal processing method of neurons. It should be noted that in simulated neuromorphic hardware (such as brain-inspired chips), the concept of (simulation) time step does not exist, and the above-mentioned “multi-spike” cannot be generated. Therefore, in the actual simulated neuromorphic hardware, the aforementioned multiple spikes of amplitude and angle may appear in the form of multiple continuous spikes (equal to the aforementioned unit amplitude multiples) on the time axis. For example, a spike with an amplitude of 5 units is generated in the training algorithm, and correspondingly, 5 spikes with a fixed amplitude are continuously generated in the simulated neuromorphic device. However, in another type of embodiment, the multi-spike information may also be carried (or contained) by a spiking event in a neural network accelerator (such as a neuromorphic chip). For example, a spiking event carries (or contains) an integer to represent that it conveys a multi-spike.

In summary, the above discloses a signal processing method for neurons in a spiking neural network, the spiking neural network comprises a plurality of layers, each of the layers comprises a plurality of neurons, and the signal processing method comprises following steps: a receiving step: at least one neuron configured to receive at least one path of input spike train; an accumulation step: performing weighted summation based on the at least one path of input spike train to obtain a membrane potential; and an activation step: when the membrane potential exceeds a threshold value, determining an amplitude of a spike fired by the at least one neuron based on a ratio of the membrane potential to the threshold value.

The above neuron signal processing method can exist as a basic module/step of a training method of a spiking neural network. The spiking neural network may include several above-mentioned neurons, and thus constitute several layers of the network.

In fact, the reasoning phase of the neural network can also apply the above-mentioned signal processing method of the neurons. The neurons included in a neural network accelerator, such as a neuromorphic chip, apply the signal processing method of the neurons described above when performing reasoning functions.

The above neuron model can be applied to various neural network architectures, such as various existing network architectures and a new neural network architecture. The present invention does not limit the specific neural network architecture.

2. Surrogate Gradient

In the network training phase, a network prediction error needs to be transmitted to each layer of the network to adjust a configuration parameter such as weights. The loss function value of the network is minimized, which is an error backpropagation training method of the network. Different training methods may lead to different network training performance and efficiency. There are many training schemes in the prior art, but these training methods are basically based on the concept of gradient, especially the traditional ANN network. For this reason, the training method of the spiking neural network in the present invention relates to the following technical means:

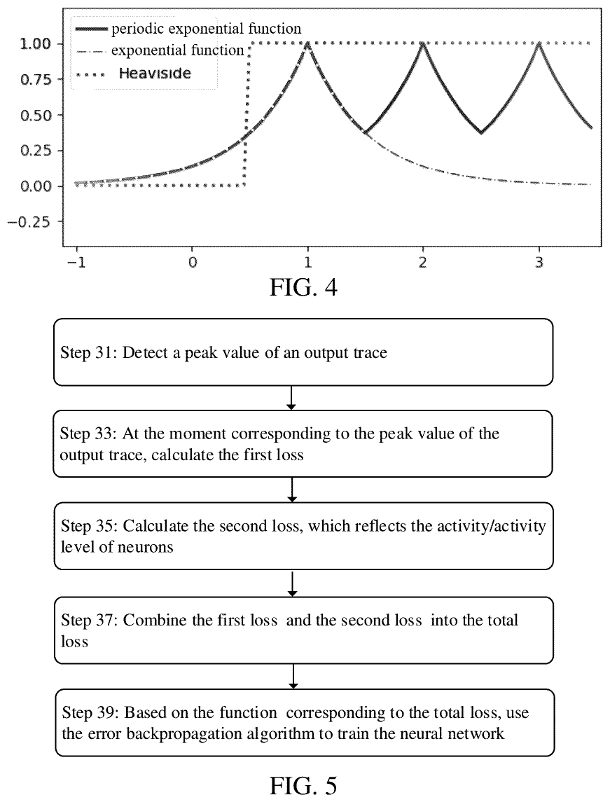

In order to solve the non-differentiable issue of SNN spike gradient, the present invention uses a surrogate gradient scheme. In an embodiment, with reference to FIG. 4, in order to adapt to a multi-spike behavior of neurons, the scheme selects a periodic exponential function as the surrogate gradient in the backpropagation phase of the training process, and the present invention does not limit the specific parameters of the periodic exponential function. This periodic exponential function emits spikes when the membrane potential exceeds the neuron's threshold value N (≥1) times. The gradient function maximizes the influence of parameters when a neuron is about to emit a spike or has emitted the spike, and the gradient function is a variant of the periodic exponential function.

A minimalist form of the periodic exponential function is Heaviside function as illustrated in FIG. 4. The Heaviside function is similar to ReLU unit, which has a limited range of membrane potentials and a gradient of 0, and this would likely prevent the neural network from learning at low levels of activity. In an alternative embodiment, the above-mentioned Heaviside function is used as the surrogate gradient during the backpropagation phase of the training process.

The above surrogate gradient scheme can be applied to various backpropagation training models, such as a brand-new training model, and the present invention does not limit the specific training scheme.

3. Loss Function

In the training method of the spiking neural network, a loss function is generally involved, which is an evaluation index for the training result of the current network. The larger the loss value, the worse the performance of the network, and vice versa. In the present invention, the training method of spiking neural network involves the following technical means:

A training method of a spiking neural network, wherein the spiking neural network comprises a plurality of layers, and each of the layers comprises a plurality of neurons, comprising:
when the neurons process signals in a network training, following steps are included:
a receiving step: at least one neuron configured to receive at least one path of input spike train;
an accumulation step: performing weighted summation based on the at least one path of input spike train to obtain a membrane potential; and
an activation step: when the membrane potential exceeds a threshold value, determining an amplitude of a spike fired by the at least one neuron based on a ratio of the membrane potential to the threshold value;
wherein a total loss of the spiking neural network comprises a first loss and a second loss, the first loss reflects a gap between an expected output of the spiking neural network and an actual output of the spiking neural network, and the second loss reflects an activity or an activity level of the neuron.

In classification tasks, generally, a cross entropy of a sum of outputs over the sample length is calculated for each output neuron to determine the category/class of the output. While this would yield decent classification accuracy, the magnitude of the output trace at a given moment is not indicative of the network's predictions. In other words, this approach does not work in streaming mode. To this end, referring to FIG. 5, we designed a new total loss function [symbol] (∩) and a training method of a spiking neural network. A total loss of the spiking neural network comprises a first loss and a second loss, the first loss reflects a gap between an expected output of the spiking neural network and an actual output of the spiking neural network, and the second loss reflects an activity/activity level of the neuron. The embodiment specifically includes:
Step 31: Detect a peak value of an output trace.
Step 33: At the moment corresponding to the peak value of the output trace, calculate the first loss CE. In an embodiment, the first loss is determined based on a cross entropy loss function. Specifically, the cross-entropy loss function is:

$${ℒ}_{C E} = - {\sum }_{c} {λ}_{c} log ( {p}_{c} ) .$$

When a class label of a category c (i.e., category c) matches a current input, λc=1, or otherwise λc=0; p_{c} is an indicator of a relative possibility that a neural network predicts that the current input belongs to the category c (such as probability/odds or some kind of function mapping value). The first loss reflects a gap between an expected output of the spiking neural network and an actual output of the spiking neural network.

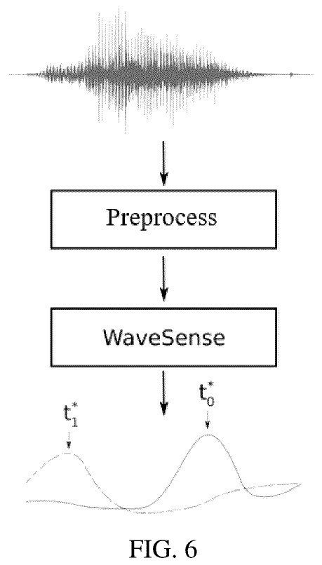

The moment corresponding to the peak value of the output trace may be referred to as a peak moment t_{c}*. Referring to FIG. 6, the output trace can be activated to the maximum extent at this moment.

The indicator p_{c} of a relative possibility that a neural network predicts that the current input belongs to the category c can be calculated by a softmax function:

$${p}_{c} = \frac{{e}^{{\hat{y}}_{c}}}{{\sum }_{i} {e}^{{\hat{y}}_{i}}} .$$

Both ŷ_{c} and ŷᵢ are logits values output by the neural network, i is a count mark of the ith category, ŷ_{c} is a fraction of an input data belonging to the category c, ŷᵢ is a fraction of an input data belonging to the ith category, e is a base number of a natural logarithm function, and the denominator is to sum eŷᵢ corresponding to all categories.

For time domain tasks, input x=x^{T}=x^{1,2,4,3 . . . T}, the output of the neural network (logits value) is a time series over time T. The neural network output at time t: [symbol] = [symbol] (x^{t}|Θ, [symbol] ^{t}).

[symbol] (·) is a transformation of the neural network, Θ is a configuration parameter of the neural network, and [symbol] is an internal state of the network at time t.

For peak-loss, the present invention feeds a peak of each output trace into the softmax function, and the peak is obtained as follows: ŷ_{c}=max( [symbol] )= [symbol] .

t_{c}*=argmax( [symbol] ), that is, the peak moment mentioned above. Referring to FIG. 6, it is the time when the output trace can be activated to the maximum.

Applicant has discovered that the activity of LIF neurons can change dramatically during the learning process. This can occur by sending spikes at a high rate at each time step potentially eliminating the advantage of using spiking neurons and thus no longer having sparsity. This may lead to high energy consumption of simulated neuromorphic devices implementing such networks.

Step 35: Calculate the second loss [symbol] _{act}, which reflects the activity/activity level of neurons.

In order to suppress/limit the activity/activity level of neurons while still maintaining sparse activity, the second loss [symbol] ₐᵣₜ is also included in the total loss [symbol] . The total loss [symbol] is the combined/included loss of the first loss [symbol] _{CE} and the second loss [symbol] _{act}. The second loss, also known as activation loss, is a loss set to punish activation of too many neurons.

Optionally, the second loss is defined as follows: [symbol] _{act}=(Nₛₚₖ^{†}/(T·Nₙₑᵤᵣₒₙₛ))². The second loss depends on the total excess number of spikes Nₛₚₖ^{†} produced by a population of neurons of size Nₙₑᵤᵣₒₙₛ in response to an input of duration T. Nₛₚₖ^{†}=Σₜ₌₁^{T}ΣᵢNᵢ^{t}H(Nᵢ^{t}−1). Here H(·) is Heaviside function, and Nᵢ^{t} is the ith neuron at a time step t. Nₛₚₖ⁺ is also the sum of the spikes of all neurons Ni exceeding 1 in each time bin.

Step 37: Combine the first loss [symbol] _{CE} and the second loss [symbol] _{act} into the total loss [symbol] .

In an embodiment, the above-mentioned combination method is: [symbol] = [symbol] _{CE}+α [symbol] _{act}. The parameter α is a tuning parameter, optionally equal to 0.01. In an alternative embodiment, the above combining manner also includes any other reasonable manner that takes the second loss into consideration, such as combining the first loss and the second loss in a non-linear manner.

Here, the total loss, the first loss and the second loss all refer to the value of the corresponding loss function. These losses are calculated based on the corresponding loss function, such as [symbol] (·), [symbol] _{CE}(·), [symbol] ₐᵣₜ(·).

Step 39: Based on the function [symbol] (·) corresponding to the total loss, use the error backpropagation algorithm to train the neural network.

Backpropagation through time (BPTT) is a gradient-based neural network training (sometimes also called learning) method well known in the art. Usually based on the value of the loss function (in this invention, the total loss function [symbol] (·)), configuration parameters such as weights of the neural network are adjusted in feedback. Finally, the value of the loss function is optimized toward the direction of minimization, and the learning/training process is completed.

For the present invention, any reasonable BPTT algorithm can be applied to the above training, and the present invention does not limit the specific form of the BPTT algorithm.

Although the above steps are supplemented by numbers to distinguish them, the size of these numbers does not imply the absolute execution order of the steps, and the difference between the numbers does not imply the number of other steps that may exist.

4. Neural Network Related Products

In addition to the aforementioned neural network architecture and training methods, the present invention also discloses the following products related to neural networks. Due to space limitations, the aforementioned neural network architecture and training methods may not be repeated here. In the following, any one or more of the aforementioned neural network architectures and their training methods may be included in related products by way of reference and may be regarded as a part of the product.

A training device comprises a memory and at least one processor coupled to the memory, wherein the at least one processor is configured to execute the training method of the spiking neural network included in any of the above methods.

The training device can be an ordinary computer, a server, a training device dedicated to machine learning (such as a computing device including a high-performance GPU), a high-performance computer, an FPGA device, an ASIC device, etc.

A storage device is configured to store a source code written by the training method of the spiking neural network included in any of the above methods through a programming language, or/and machine codes that is directly runnable on a machine.

The storage device includes but is not limited to memory carriers such as RAM, ROM, magnetic disk, solid-state hard disk, and optical disk. It may be a part of the training device, or it may be remotely separated from the training device.

A neural network accelerator comprises a neural network configuration parameter deployed on the neural network accelerator and trained by the training method of the spiking neural network included in any of the above methods.

A neural network accelerator comprises when the neurons included in the neural network accelerator perform reasoning functions, the above signal processing method for neurons is applied.

In an embodiment, a spiking event of the neural network accelerator comprises an integer.

A neural network accelerator is a hardware device used to accelerate the calculation of a neural network model. The neural network accelerator may be a coprocessor configured on a side of a CPU and configured to perform specific tasks, such as event-triggered detection such as keyword detection.

A neuromorphic chip comprises a neural network configuration parameter deployed on the neuromorphic chip and trained by the training method of the spiking neural network included in any of the above methods.

The neuromorphic chip/brain-inspired chip, that is, a chip developed by simulating the working mode of biological neurons, usually based on event triggering, has the characteristics of low power consumption, low latency response, and no privacy disclosure. Existing neuromorphic chips include Intel's Loihi, IBM's TrueNorth, Synsense's Dynap-CNN, etc.

A neural network configuration parameter deployment method is configured to deploy the neural network configuration parameter trained by the training method of the spiking neural network included in any of the above methods to a neural network accelerator.

Through dedicated deployment software, in the deployment phase, the configuration data (it may be directly stored in the training device, or may be stored in a dedicated deployment device not shown) generated in the training phase is transmitted to the storage unit such as the storage unit of the simulated synapse, etc. of the neural network accelerator (such as artificial intelligence chips, mixed-signal brain-inspired chips), through a channel (such as cables, various types of networks, etc.) In this way, the configuration parameter deployment process of the neural network accelerator can be completed.

A neural network configuration parameter deployment device is configured to store the neural network configuration parameter trained by the training method of the spiking neural network included in any of the above methods and transmit the configuration parameter to a neural network accelerator through a channel.

5. Performance Test

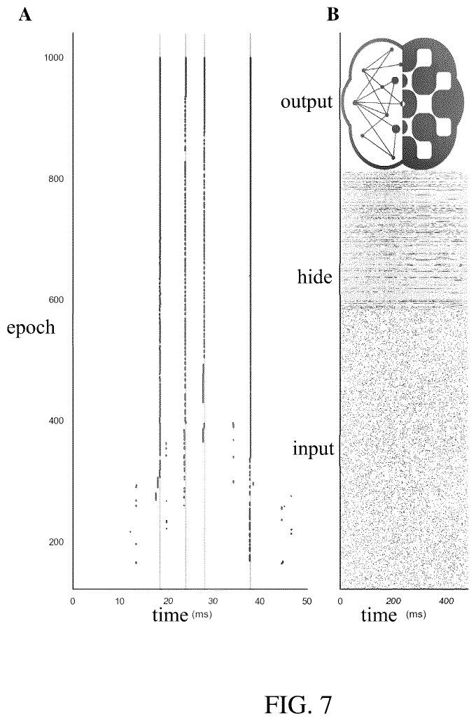

First of all, the multi-spike mechanism provided by the present invention will not affect the normal function of the network model. To verify this conclusion, as an example, using the network and training method described in prior art 1, Applicant repeated the spike pattern task in prior art 1, the repeated validation model includes 250 input neurons to receive random/frozen inputs and 25 hidden neurons to learn precise spike times. Referring to part A of FIG. 7, SNN can complete the precise spike times after about 400 epochs, while the original model needs 739 epochs to reach the convergence state.

Similarly, in addition to the spike times can be accurately learned, in order to further verify that the spike number can also be accurately learned, similar to the previous experiments, this time we train a population of neurons to emit spikes in the patterns of RGB images, the target image has 3 channels of 350*355 pixels and defines the first dimension as time and the other dimension as neurons. From this, we train 1065 neurons to emit spikes reflecting pixel values in all 3 channels and plot their output spike trains into an RGB map. As illustrated in part B of FIG. 7, the spike patterns can accurately reflect Logo, which proves that the population of neurons can accurately learn the spike times and the number of spikes.

Similarly, in addition to the spike times can be accurately learned, in order to further verify that the spike number can also be accurately learned, similar to the previous experiments, this time we train a population of neurons to emit spikes in the patterns of RGB images, the target image has 3 channels of 350*355 pixels and defines the first dimension as time and the other dimension as neurons. From this, we train 1065 neurons to emit spikes reflecting pixel values in all 3 channels and plot their output spike trains into an RGB map. As illustrated in part B of FIG. 7, the spike patterns can accurately reflect Logo, which proves that the population of neurons can accurately learn the spike times and the number of spikes.

TABLE 1
Performance on N-MNIST dataset under different models

| | | | Test (with | |
|---|---|---|---|---|
| | Training | Test | spike | Time |
| Model | (%) | (%) | output, %) | Consuming |
| IAF (The present invention) | 99.62 | 98.61 | 98.39 | 6.5 hours |
| LIF (The present invention) | 99.49 | 97.93 | 95.75 | 6.5 hours |
| SRM (SLAYER) | 95.85 | 93.41 | 93.41 | 42.5 hours |

Table 1 shows the performance of different models on the N-MNIST dataset. For the scheme using the IAF neuron model, the performance is the best under this data set, whether it is the training or the test set, the performance is the best, followed by the LIF model, and the training time of both is 6.5 hours. The model in the prior art 1 shown in the last row takes 42.5 hours to train, which is about 6-7 times that of the proposed scheme, and the accuracy is not as good as the proposed new scheme.

TABLE 2
Effects of spike generation mechanisms of different coding layers
on accuracy performance at different time step lengths

| IAF | | Multi-spike | Multi-spike | Single-spike | Single-spike |
|---|---|---|---|---|---|
| time step | | (Training) | (Test) | (Training) | (Test) |
| 1 | ms | 100 | 94.0 | 100 | 93.0 |
| 5 | ms | 99.6 | 96.0 | 99.4 | 87.0 |
| 10 | ms | 100 | 96.0 | 98.2 | 86.0 |
| 50 | ms | 99.7 | 93.0 | 95.8 | 81.0 |
| 100 | ms | 100 | 94.0 | 95.3 | 87.0 |

Table 2 shows the comparison of network performance in the face of the small N-MNIST dataset, with the same network structure, but at different time step lengths (1-100 ms), and only with different encoding mechanisms (i.e., generate multiple spikes or single spike) for the input signal at the encoding layer. It can be seen from the table that even in the encoding layer, as the time step increases, the network performance of the single-spike mechanism decreases most obviously, especially for the test set, no matter in the training phase or the testing phase. This result also highlights the performance advantage of the multi-spike mechanism in terms of precision.

Although the present invention has been described with reference to specific features and embodiments thereof, various modifications and combinations can be made thereto without departing from the present invention. Accordingly, the specification and drawings should be considered simply as illustrations of some embodiments of the present invention as defined by the appended claims and are intended to cover any and all modifications, changes, combinations, or equivalents which fall within the scope of the present invention. Therefore, although the present invention and its advantages have been described in detail, various changes, substitutions, and alterations can be made hereto without departing from the present invention as defined by the appended claims. Furthermore, the scope of the present application is not intended to be limited to the particular embodiments of the process, machine, manufacture, composition of matter, means, methods, and steps described in the specification.

Those of ordinary skill in the art may readily appreciate from this disclosure that currently existing or later developed processes, machines, manufacture, compositions of matter, means, methods, or steps that perform substantially the same function or achieve substantially the same result as the corresponding embodiments described herein can be employed in accordance with the present invention. Accordingly, the appended claims are intended to include within their scope such processes, machines, manufacture, compositions of matter, means, methods, or steps.

In order to achieve better technical effects or meet the requirements of certain applications, those skilled in the art may make further improvements to the technical solution on the basis of the present invention. However, even if this part of the improvement/design is creative or/and progressive, as long as the technical features covered by the claims of the present invention are utilized, according to the “comprehensive coverage principle”, the technical solution should also fall within the protection scope of the present invention.

Several technical features mentioned in the appended claims may have alternative technical features, or the order of certain technical processes and the order of material organization may be reorganized. After those of ordinary skill in the art know the present invention, it is easy to think of these replacement means, or change the order of the technical process and the order of material organization, and then adopt basically the same means to solve basically the same technical problems and achieve basically the same technical effect. Therefore, even if the above-mentioned means or/and sequence are clearly defined in the claims, such modifications, changes, and replacements should all fall within the protection scope of the claims based on the “principle of equivalents”.

For those with specific numerical limits in the claims, usually, those skilled in the art can understand that other reasonable numerical values around this numerical value can also be applied in a specific implementation manner. These design schemes that avoid details without departing from the concept of the present invention also fall within the protection scope of the claims.

The method steps and units described in the embodiments disclosed herein can be realized by electronic hardware, computer software, or a combination of both. In order to clearly illustrate the interchangeability of hardware and software, the steps and components of each embodiment have been generally described in terms of functions in the above description. Whether these functions are executed by hardware or software depends on the specific application and design constraints of the technical solution. Those skilled in the art may use different methods to implement the described functions for each specific application, but such implementation should not be regarded as exceeding the protection scope claimed by the present invention.

1. A signal processing method for neurons in a spiking neural network, wherein the spiking neural network comprises a plurality of layers, each of the layers comprises a plurality of neurons, and the signal processing method comprises following steps:
a receiving step: at least one neuron configured to receive at least one path of input spike train;
an accumulation step: performing weighted summation based on the at least one path of input spike train to obtain a membrane potential; and
an activation step: when the membrane potential exceeds a threshold value, determining an amplitude of a spike fired by the at least one neuron based on a ratio of the membrane potential to the threshold value.

2. The signal processing method for neurons in the spiking neural network as claimed in claim 1, wherein determining the amplitude of the spike fired by the at least one neuron based on the ratio of the membrane potential to the threshold value comprises:
wherein in a single-simulation time step, an amplitude of an fired spike is related to the ratio of the membrane potential to the threshold value.

3. The signal processing method for neurons in the spiking neural network as claimed in claim 1, wherein determining the amplitude of the spike fired by the at least one neuron based on the ratio of the membrane potential to the threshold value comprises:
wherein in a single-simulation time step, the ratio of an amplitude of an fired spike to a unit spike amplitude is equal to a rounded down value of the ratio of the membrane potential to the threshold value.

4. The signal processing method for neurons in the spiking neural network as claimed in claim 1, wherein performing weighted summation based on the at least one path of input spike train to obtain the membrane potential comprises: performing weighted summation based on a post synaptic potential kernel convolved with each path of input spike train to obtain the membrane potential.

5. The signal processing method for neurons in the spiking neural network as claimed in claim 4, wherein performing weighted summation based on the at least one path of input spike train to obtain the membrane potential comprises: performing weighted summation based on the post synaptic potential kernel convolved with each path of input spike train and performing convolution of a refractory kernel with an output spike train of the neuron to obtain the membrane potential.

6. The signal processing method for neurons in the spiking neural network as claimed in claim 4, wherein:
$$v ( t ) = {\sum }_{j} {ω}_{j} ( ϵ * {s}_{j} ) ( t ) ,$$
wherein ν(t) is the membrane potential of the neuron, ωⱼ is a jth synaptic weight, ϵ(t) is the post synaptic potential kernel, sⱼ (t) is a jth input spike train, “*” is a convolution operation, and t is time.

7. The signal processing method for neurons in the spiking neural network as claimed in claim 5, wherein:
$$v ( t ) = ( η * {s}^{′} ) ( t ) + {\sum }_{j} {ω}_{j} ( ϵ * {s}_{j} ) ( t ) ,$$
wherein ν(t) is the membrane potential of the neuron, η(t) is the refractory kernel, s′(t) is the output spike train of the neuron, ωⱼ is a jth synaptic weight, ϵ(t) is the post synaptic potential kernel, sⱼ(t) is a jth input spike train, ‘*’ is a convolution operation, and t is time.

8. The signal processing method for neurons in the spiking neural network as claimed in claim 6, wherein the post synaptic potential kernel is ϵ(t)=(ϵₛ*ϵ_{ν})(t), a synaptic dynamic function is ϵₛ(t)=e^{-t/τ}^{ₛ}, a membrane dynamic function is ϵ_{ν}(t)=e^{-t/τ}^{_{ν}}, τₛ is a synaptic time constant, τ_{ν} is a membrane time constant, and t is time.

9. The signal processing method for neurons in the spiking neural network as claimed in claim 7, wherein the post synaptic potential kernel is ϵ(t)=(ϵₛ*ϵ_{ν})(t), a synaptic dynamic function is ϵₛ(t)=e^{-t/τ}^{ₛ}, a membrane dynamic function is ϵ_{ν}(t)=e^{-t/τ}^{_{ν}}, τₛ is a synaptic time constant, τ_{ν} is a membrane time constant, and t is time; the refractory kernel is η(t)=−θe^{-t/τ}^{_{ν}}, θ is the threshold value, and when ν(t)≥θ, s′(t)=└ν(t)/θ┘, or otherwise s′(t)=0.

10. A training method of a spiking neural network, wherein the spiking neural network comprises a plurality of layers, and each of the layers comprises a plurality of neurons, comprising:
when the neurons process signals in a network training, following steps are included:
a receiving step: at least one neuron configured to receive at least one path of input spike train;
an accumulation step: performing weighted summation based on the at least one path of input spike train to obtain a membrane potential; and
an activation step: when the membrane potential exceeds a threshold value, determining an amplitude of a spike fired by the at least one neuron based on a ratio of the membrane potential to the threshold value;
wherein a total loss of the spiking neural network comprises a first loss and a second loss, the first loss reflects a gap between an expected output of the spiking neural network and an actual output of the spiking neural network, and the second loss reflects an activity or an activity level of the at least one neuron.

11. The training method of the spiking neural network as claimed in claim further comprising:
detecting a peak value of an output trace;
calculating the first loss at a moment corresponding to the peak value of the output trace;
calculating the second loss, wherein the second loss reflects the activity or the activity level of the at least one neuron;
combining the first loss and the second loss into the total loss; and
using an error backpropagation algorithm to train a neural network based on a function corresponding to the total loss.

12. The training method of the spiking neural network as claimed in claim 11, wherein combining the first loss and the second loss into the total loss comprises: [symbol] = [symbol] _{CE}+α [symbol] _{act}, where a parameter α is an adjustment parameter, the total loss is [symbol] , the first loss is [symbol] _{CE}, and the second loss is [symbol] _{act}.

13. The training method of the spiking neural network as claimed in claim 10, wherein the second loss is [symbol] _{act}=(Nₛₚₖ^{†}/(T·Nₙₑᵤᵣₒₙₛ))², where T is a duration, Nₙₑᵤᵣₒₙₛ is a size of a population of neurons, Nₛₚₖ^{†}=Σₜ₌₁^{T}ΣᵢNᵢ^{t}H(Nᵢ^{t}−1), H(·) is a Heaviside function, and Nᵢ^{t} is an ith neuron in a time step t.

14. The training method of the spiking neural network as claimed in claim 10, wherein the first loss is
$${ℒ}_{C E} = - {\sum }_{c} {λ}_{c} log ( {p}_{c} ) ,$$
when a class label of a category c matches a current input, λc=1, or otherwise λc=0; p_{c} is an indicator of a relative possibility that a neural network predicts that the current input belongs to the category c.

15. The training method of the spiking neural network as claimed in claim 10, further comprising using a periodic exponential function or a Heaviside function as a surrogate gradient.

16-19. (canceled)

20. A neuromorphic chip, comprising a neural network configuration parameter deployed on the simulated neuromorphic chip and trained by a training method of a spiking neural network, wherein the spiking neural network comprises a plurality of layers, each of the layers comprises a plurality of neurons, and the training method of the spiking neural network comprises:
when the neurons process signals in a network training, following steps are included:
a receiving step: at least one neuron configured to receive at least one path of input spike train;
an accumulation step: performing weighted summation based on the at least one path of input spike train to obtain a membrane potential; and
an activation step: when the membrane potential exceeds a threshold value, determining an amplitude of a spike fired by the at least one neuron based on a ratio of the membrane potential to the threshold value;
wherein a total loss of the spiking neural network comprises a first loss and a second loss, the first loss reflects a gap between an expected output of the spiking neural network and an actual output of the spiking neural network, and the second loss reflects an activity or an activity level of the at least one neuron.

21. The neuromorphic chip as claimed in claim 20, wherein the training method of the spiking neural network further comprising:
detecting a peak value of an output trace;
calculating the first loss at a moment corresponding to the peak value of the output trace;
calculating the second loss, wherein the second loss reflects the activity or the activity level of the at least one neuron;
combining the first loss and the second loss into the total loss; and
using an error backpropagation algorithm to train a neural network based on a function corresponding to the total loss.

22. The neuromorphic chip as claimed in claim 21, wherein combining the first loss and the second loss into the total loss comprises: [symbol] = [symbol] _{CE}+α [symbol] _{act}, where a parameter α is an adjustment parameter, the total loss is [symbol] , the first loss is [symbol] _{CE}, and the second loss is [symbol] _{act}.

23. The neuromorphic chip as claimed in claim 20, wherein the second loss is [symbol] _{act}=(Nₛₚₖ^{†}/(T·Nₙₑᵤᵣₒₙₛ))², where T is a duration, Nₙₑᵤᵣₒₙₛ is a size of a population of neurons, Nₛₚₖ^{†}=Σₜ₌₁^{T}ΣᵢNᵢ^{t}H(Hᵢ^{t}−1), H(·) is a Heaviside function, and Nᵢ^{t} is an ith neuron in a time step t.

24. The neuromorphic chip as claimed in claim 20, wherein the first loss is
$${ℒ}_{C E} = - {\sum }_{c} {λ}_{c} log ( {p}_{c} ) ,$$
when a class label of a category c matches a current input, λc=1, or otherwise λc=0; p_{c} is an indicator of a relative possibility that a neural network predicts that the current input belongs to the category c.
